(19) United States
(12) Patent Application Publication
(10) Pub. No.: US 2023/0001592 A1
(43) Pub. Date: Jan. 5, 2023

(54) Handheld Clippers

(71) Applicant: John W. Lyles, Cherry Hill, NJ (US)

(72) Inventor: John W. Lyles, Cherry Hill, NJ (US)

(21) Appl. No.: 17/810,562

(22) Filed: Jul. 1, 2022

Related U.S. Application Data
(60) Provisional application No. 63/217,712, filed on Jul. 1, 2021.

(51) Int. Cl. B26B 19/06; B26B 19/38; B26B 19/28

(52) U.S. Cl. CPC B26B 19/063; B26B 19/3853; B26B 19/3873; B26B 19/28

(57) ABSTRACT

A hair clipper apparatus suitable for shaving in wide angles is presented. The hair clipper apparatus contains a handle housing, a clipper head, a motor, a power supply, a power switch, a first movement guide, and a second movement guide. The handle housing contains a head receiver. The clipper head contains a head connector and a shaver head. The motor is positioned within the handle housing. The motor is rotatably mounted to the stator body. The head connector is hingedly connected to the head receiver by the first movement guide. The shaver head is hingedly connected to the head connector, opposite to the shaver head, by the second movement guide. A first rotation axis of the first movement guide and a second rotation axis of the second movement guide is positioned perpendicular to each other. The motor is operatively coupled to the shaver head. The power switch is electrically connected between the power supply and the motor.

The current application claims a priority to the U.S. provisional patent application Ser. No. 63/217,712 filed on Jul. 1, 2021.

### FIELD OF THE INVENTION

The present invention relates generally to hair care and grooming. More specifically, the present invention is a hair clipper that easily fits in the palm of the user's hand and pivots to allow sharper cutting angles.

### BACKGROUND OF THE INVENTION

Cutting hair with hair clippers is one of the most common methods across the world and is used by professional barbers worldwide. Most hair clippers can be used to cut hair to a smaller length. This includes hair on the face and on the head. These hair clippers come in a variety of shapes and sizes but are typically too bulky to get desired results. Often, barbers are burdened with maneuvering bulky clippers around a client's head. Fatigue and inaccuracy are both consequences of having bulky clippers due to the weight and limited angles that the clippers allow. Most clippers also have an attached cord that supplies power from a socket. The cord can cause a major inconvenience to barbers by blocking the barber's vision and getting tangled in a client's hair. Sometimes, barbers have to flick the clippers to whip the cord away which can possibly introduce errors in the haircut. Bulky and corded clippers can produce inaccurate haircuts that can anger clients and overall decrease business.

An objective of the present invention is to increase cutting angles and comfort to barbers so they can provide more accurate haircuts to clients. The present invention is a small clipper that can adjust to different cutting angles. The present invention also comprises a grip that fits perfectly into a user's hand. The handheld clipper can increase accurate haircuts which result in more satisfied customers.

### SUMMARY OF THE INVENTION

The present invention is a cordless clipper that can pivot to provide more accurate haircuts. The present invention comprises a small grip, a hinge mechanism, and a set of blades. The grip allows users to easily handle the clipper while cutting hair. The hinge, rotating, and lever mechanisms ensure that multiple cutting angles are accessible during a haircut to accommodate different haircut styles. The present invention can charge though a charge port and comprises a backlit display that shows the battery life among other features. The small design also allows more maneuverability and portability for users. Additional benefits and features are further discussed below.

### BRIEF DESCRIPTION OF THE DRAWINGS

FIG. 1 is a top perspective view of the present invention.

FIG. 2 is a top perspective exploded view of the present invention.

FIG. 3 is a bottom perspective exploded view of the present invention.

FIG. 4 is a circuit schematic diagram used in the present invention.

### DETAIL DESCRIPTIONS OF THE INVENTION

All illustrations of the drawings are for the purpose of describing selected versions of the present invention and are not intended to limit the scope of the present invention. The present invention is to be described in detail and is provided in a manner that establishes a thorough understanding of the present invention. There may be aspects of the present invention that may be practiced or utilized without the implementation of some features as they are described. It should be understood that some details have not been described in detail in order to not unnecessarily obscure focus of the invention. References herein to “the preferred embodiment”, “one embodiment”, “some embodiments”, or “alternative embodiments” should be considered to be illustrating aspects of the present invention that may potentially vary in some instances, and should not be considered to be limiting to the scope of the present invention as a whole.

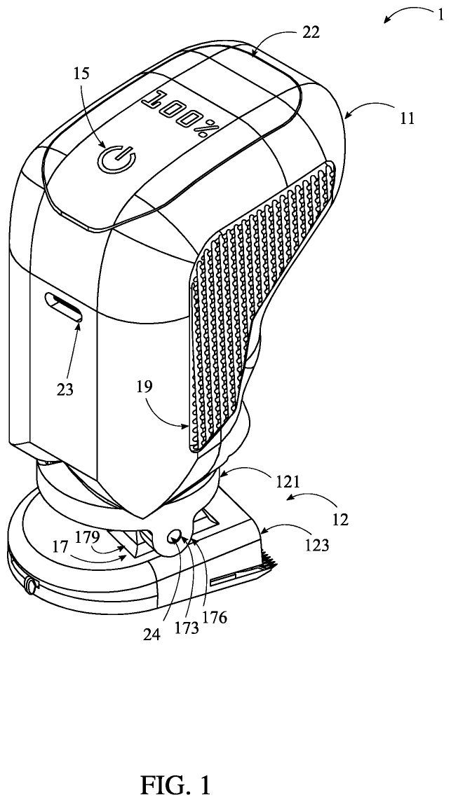

In reference to FIGS. 1-4, the present invention is a hair clipper apparatus 1 comprises a handle housing 11, a clipper head 12, a motor 13, a power supply 14, a power switch 15, a first movement guide 16, and a second movement guide 17. The handle housing 11 comprises a shaft aperture 111 and a head receiver 112. The clipper head 12 comprises a head connector 121 and a shaver head 123. The motor 13 comprises a rotary shaft 131 and a stator body 132. In the preferred embodiment, the hair clipper apparatus 1 features a multi-axial shaving element that provides enhanced and wider cutting angles compared to conventional shavers. In the preferred embodiment, the handle housing 11 takes the form of an ergonomic grasping element that allows the user to grasp the hair clipper apparatus 1 with comfort and ease. In the preferred embodiment, the handle housing 11 also serves as the main body that houses the components the constitutes the hair clipper apparatus 1. In the preferred embodiment, the clipper head 12 serves as the main shaving element of the hair clipper apparatus 1 that mounts on the handle housing 11. In the preferred embodiment, the motor 13 takes the form of any suitable electrical motor 13 suitable in powering the clipper head 12. In the preferred embodiment, the power supply 14 takes the form of any suitable powering element, such as, but not to AC to DC adapters, disposable batteries, rechargeable batteries, or any other powering implement that provides electrical power to the motor 13. In the preferred embodiment, the power switch 15 takes the form of any suitable electrical switch that enables the user to control and activate the hair clipper apparatus 1 to an “on” configuration or an “off” configuration. In the preferred embodiment, the first movement guide 16 takes the form of any suitable adjustable pivoting element that pivots the clipper head 12 in one axial direction. In the preferred embodiment, the second movement guide 17 takes the form of any suitable adjustable pivoting element that pivots the shaver head 123 along the head connector 121 in another axial direction. The shaft aperture 111 serves as an access opening for the rotary shaft 131 to pass through the handle housing 11. The head receiver 112 serves as the primary mounting element to mount the clipper head 12 to the handle housing 11. In the preferred embodiment, the head connector 121 serves at the primary mounting element to mount along the head receiver 112. In the preferred embodiment, the shaver head 123 takes the form of the shaving element of the hair clipper apparatus 1 that is operated by the motor 13. The rotary shaft 131 serves as the drive shaft of the motor 13 that is operatively coupled to the shaver head 123. The stator body 132 serves as the stationary portion of the motor 13 that is secured within the handle housing 11.

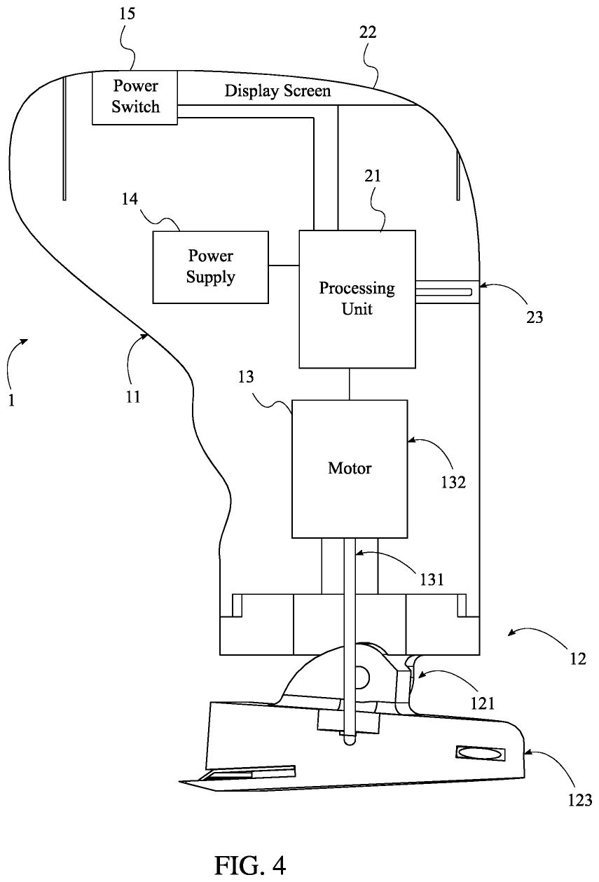

The general configuration of the aforementioned components allows the present invention to perform wider cutting angles along a shaved area with ease. In reference to FIGS. 1-4, the shaft aperture 111 traverses into the handle housing 11, where the shaft aperture 111 is configured to allow the rotary shaft 131 of the motor 13 to pass through the handle housing 11, shown in FIG. 4. The head receiver 112 is positioned around the shaft aperture 111, where the head receiver 112 is configured to align the clipper head 12 along the rotary shaft 131. The stator body 132 is connected within the handle housing 11, where the stator body 132 is secured and concealed within the handle housing 11. The rotary shaft 131 is rotatably mounted to the stator body 132, where the rotary shaft 131 is configured to spin along the stator body 132. The rotary shaft 131 is positioned through the shaft aperture 111. The head connector 121 is hingedly connected to the head receiver 112 by the first movement guide 16, where the head connector 121 freely pivots along the head receiver 112. The shaver head 123 is hingedly connected to the head connector 121, opposite to the shaver head 123, by the second movement guide 17, where the shaver head 123 is configured to pivot along the head connector 121. The first rotation axis 161 of the first movement guide 16 and a second rotation axis 171 of the second movement guide 17 is positioned perpendicular to each other. The rotary shaft 131 is operatively coupled to the shaver head 123, wherein the rotary shaft 131 is used to drive a functional motion of the shaver head 123. The power switch 15 is electrically connected between the power supply 14 and the motor 13.

In reference to FIGS. 1-3, the hair clipper apparatus 1 further comprises a plurality of textured grips 19. The plurality of textured grips 19 takes the form of textured grasping layers that enhances gripping and handling of the handle housing 11. In the preferred embodiment, the plurality of textured grips 19 takes the form of any type of grip pattern, such as, but not limited to knurling, dimpling, rubberized texturing, or any other suitable grip pattern. The plurality of textured grips 19 is externally connected about the handle housing 11, where the plurality of textured grips 19 is configured to make contact with the user's hands.

In reference to FIGS. 1-4, the hair clipper apparatus 1 further comprises a processing unit 21, and a display screen 22. In the preferred embodiment, the processing unit 21 takes the form of any suitable processing element that handles voltage regulation, display overlays, speed controls, and any other electronic and electrical processes associated with the hair clipper apparatus 1. In the preferred embodiment, the display screen 22 takes the form of any suitable electronic display, such as, but not limited to LCD, LED digital screens that supports the display overlay processes executed by the processing unit 21. The display screen 22 is externally connected along the handle housing 11 such that the user is able to view the display screen 22 along the handle housing 11. The processing unit 21 is connected within the handle housing 11, such that the processing unit 21 is secured and concealed within the handle housing 11. The display screen 22 is electronically connected to the processing unit 21, wherein the display screen 22 projects pre-programmed display overlays executed by the processing unit 21. The power supply 14, the motor 13, and the power switch 15 are electronically connected to the processing unit 21, wherein the processing unit 21 is configured to regulate voltage discharged from the power supply 14 as well as selectively operate the motor 13 when the power switch 15 is actuated by the user.

In reference to FIGS. 1-4, the hair clipper apparatus 1 further comprises a charging port 23. In the preferred embodiment, the charging port 23 takes the form of an electrical charging input that allows the user to charge the power supply 14, where the power supply 14 takes the form of rechargeable batteries. The charging port 23 is integrated into the handle housing 11, where the charging port 23 is configured to flush along the handle housing 11 such that the charging port 23 is accessible along the handle housing 11. The charging port 23 is electrically connected to the power supply 14. The charging port 23 is electronically connected to the processing unit 21.

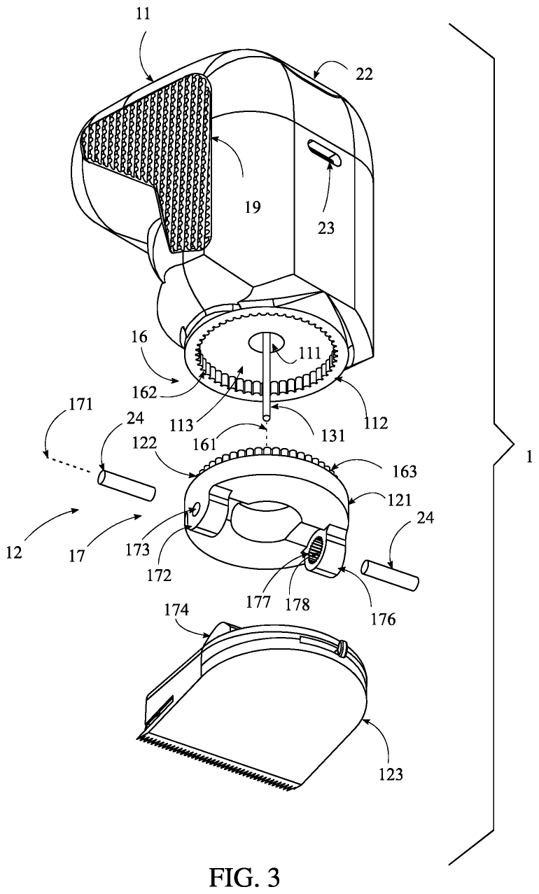

In reference to FIGS. 3-4, the head receiver 112 comprises a first detent cavity 113. The head connector 121 comprises a detent connector 122. The first movement guide 16 comprises a plurality of first detent elements 162 and a plurality of second detent elements 163. In the preferred embodiment, the first detent cavity 113 serves as a detent receiving element that receives the detent connector 122 of the head connector 121. In the preferred embodiment, the plurality of first detent elements 162 and the plurality of second detent elements 163 takes the form of any suitable detent mechanism implement that allows the user to selectively adjust the head receiver 112 from the head connector 121. The detent cavity traverses into the head receiver 112, wherein the detent cavity is configured to receive the detent connector 122. The detent connector 122 is connected adjacent to the head connector 121, opposite to the shaver head 123, wherein the detent connector 122 is configured to connect along the detent cavity. The plurality of first detent elements 162 is perimetrically distributed around the detent cavity. The plurality of second detent elements 163 is perimetrically distributed around the detent connector 122. The plurality of first detent elements 162 is enmeshed to the plurality of second detent elements 163, wherein the plurality of first detent elements 162 and the plurality of second detent elements 163 is configured to engage along each other, where the head connector 121 selectively adjusts along the head receiver 112 of the handle housing 11.

In reference to FIGS. 1-3, the hair clipper apparatus 1 further comprises a pair of mounting axles 24. The second movement guide 17 comprises a first hinge tab 172, a first fastening aperture 173, a second hinge tab 174, and a second fastening aperture 175. The pair of mounting axles 24 takes the form of a pivot connection rods that connects the first hinge tab 172 to the second hinge tab 174. In the preferred embodiment, the first hinge tab 172 and the second hinge tab 174 serves as corresponding connection members that hingedly connects the head connector 121 to the shaver head 123, respectively. In the preferred embodiment, the first fastening aperture 173 and the second fastening aperture 175 takes the form of connection apertures along the respective first hinge tab 172 and the second hinge tab 174 that enables the first hinge tab 172 and the second hinge tab 174 to hingedly connect to each other through the pair of mounting axles 24. The first hinge tab 172 is connected adjacent to the head connector 121, opposite to the handle housing 11. The first fastening aperture 173 traverses through the first hinge tab 172. The second hinge tab 174 is connected onto the shaver head 123. The second fastening aperture 175 traverses through the second hinge tab 174. The pair of mounting axles 24 is mounted through the first fastening aperture 173 and the second fastening aperture 175.

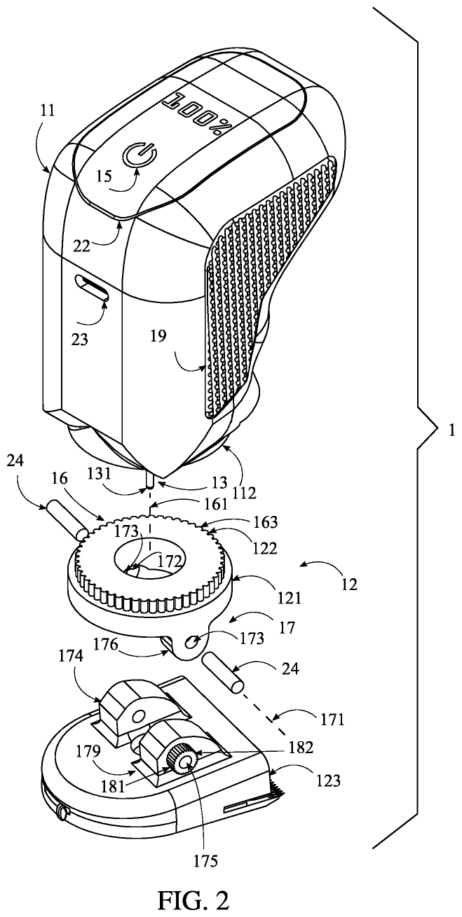

In reference to FIGS. 2-3, the second movement guide 17 further comprises a first detent tab 176, a plurality of third detent elements 177, a second detent cavity 178, a second detent tab 179, a detent knob 181, and a plurality of fourth detent elements 182. In the preferred embodiment, the first detent tab 176 facilitates the plurality of third detent elements 177. The second detent cavity 178 facilitates the plurality of fourth detent elements 182. The first detent tab 176 is connected adjacent to the head connector 121, opposite the to the handle housing 11. The first detent tab 176 is positioned offset from the first hinge tab 172. The first fastening aperture 173 further traverses through the first detent tab 176. The second detent cavity 178 traverses into the first detent tab 176. The plurality of third detent elements 177 is perimetrically distributed about the second detent cavity 178. The second detent tab 179 is connected adjacent to the shaver head 123. The second detent tab 179 is positioned offset from the second hinge tab 174. The second fastening aperture 175 traverses through the second hinge tab 174 and the second detent tab 179. The detent knob 181 is connected adjacent to the second detent tab 179. The plurality of fourth detent elements 182 is perimetrically distributed about the detent knob 181. The plurality of third detent elements 177 is enmeshed to the plurality of fourth detent elements 182, wherein the enmeshed plurality of third detent elements 177 and the plurality of fourth detent elements 182 are configured to selectively adjust the shaver head 123 along the head connector 121.

Although the invention has been explained in relation to its preferred embodiment, it is to be understood that many other possible modifications and variations can be made without departing from the spirit and scope of the invention as hereinafter claimed.

What is claimed is:

1. A hair clipper apparatus comprising:
a handle housing;
a clipper head;
a motor;
a power supply;
a power switch;
a first movement guide;
a second movement guide;
the handle housing comprising a shaft aperture and a head receiver;
the clipper head comprising a head connector and a shaver head;
the motor comprising a rotary shaft and a stator body;
the shaft aperture traversing into the handle housing;
the head receiver being positioned around the shaft aperture;
the stator body being connected within the handle housing;
the rotary shaft being rotatably mounted to the stator body;
the rotary shaft being positioned through the shaft aperture;
the head connector being hingedly connected to the head receiver by the first movement guide;
the shaver head being hingedly connected to the head connector, opposite to the shaver head, by the second movement guide;
a first rotation axis of the first movement guide and a second rotation axis of the second movement guide being positioned perpendicular to each other;
the rotary shaft being operatively coupled to the shaver head, wherein the rotary shaft is used to drive a functional motion of the shaver head; and
the power switch being electrically connected between the power supply and the motor.

2. The hair clipper apparatus as claimed in claim 1 further comprising:
a plurality of textured grips; and
the plurality of textured grips being externally connected about the handle housing.

3. The hair clipper apparatus as claimed in claim 1 further comprising:
a processing unit;
a display screen;
the display screen being externally connected along the handle housing;
the processing unit being connected within the handle housing;
the display screen being electronically connected to the processing unit; and
the power supply, the motor, and the power switch being electronically connected to the processing unit.

4. The hair clipper apparatus as claimed in claim 3 further comprising:
a charging port;
the charging port being integrated into the handle housing;
the charging port being electrically connected to the power supply; and
the charging port being electronically connected to the processing unit.

5. The hair clipper apparatus as claimed in claim 1 further comprising:
the head receiver comprising a first detent cavity;
the head connector comprising a detent connector;
the first movement guide comprising a plurality of first detent elements and a plurality of second detent elements;
the detent cavity traversing into the head receiver;
the detent connector being connected adjacent to the head connector, opposite to the shaver head;
the plurality of first detent elements being perimetrically distributed around the detent cavity;
the plurality of second detent elements being perimetrically distributed around the detent connector; and
the plurality of first detent elements being enmeshed to the plurality of second detent elements.

6. The hair clipper apparatus as claimed in claim 1 further comprising:
a pair of mounting axles;
the second movement guide comprising a first hinge tab, a first fastening aperture, a second hinge tab, and a second fastening aperture;
the first hinge tab being connected adjacent to the head connector, opposite to the handle housing;
the first fastening aperture traversing through the first hinge tab;
the second hinge tab being connected onto the shaver head;
the second fastening aperture traversing through the second hinge tab; and
the pair of mounting axles being mounted through the first fastening aperture and the second fastening aperture.

7. The hair clipper apparatus as claimed in claim 6 further comprising:
the second movement guide further comprising a first detent tab, a plurality of third detent elements, a second detent cavity, a second detent tab, a detent knob, and a plurality of fourth detent elements;
the first detent tab being connected adjacent to the head connector, opposite the to the handle housing;
the first detent tab being positioned offset from the first hinge tab;
the first fastening aperture further traversing through the first detent tab;
the second detent cavity traversing into the first detent tab;
the plurality of third detent elements being perimetrically distributed about the second detent cavity;
the second detent tab being connected adjacent to the shaver head;
the second detent tab being positioned offset from the second hinge tab;
the second fastening aperture traversing through the second hinge tab and the second detent tab;
the detent knob being connected adjacent to the second detent tab;
the plurality of fourth detent elements being perimetrically distributed about the detent knob; and
the plurality of third detent elements being enmeshed to the plurality of fourth detent elements.

8. A hair clipper apparatus comprising:
a handle housing;
a clipper head;
a motor;
a power supply;
a power switch;
a first movement guide;
a second movement guide;
the handle housing comprising a shaft aperture and a head receiver;
the clipper head comprising a head connector and a shaver head;
the motor comprising a rotary shaft and a stator body;
the head receiver comprising a first detent cavity;
the head connector comprising a detent connector;
the shaft aperture traversing into the handle housing;
the head receiver being positioned around the shaft aperture;
the stator body being connected within the handle housing;
the rotary shaft being rotatably mounted to the stator body;
the rotary shaft being positioned through the shaft aperture;
the head connector being hingedly connected to the head receiver by the first movement guide;
the shaver head being hingedly connected to the head connector, opposite to the shaver head, by the second movement guide;
a first rotation axis of the first movement guide and a second rotation axis of the second movement guide being positioned perpendicular to each other;
the rotary shaft being operatively coupled to the shaver head, wherein the rotary shaft is used to drive a functional motion of the shaver head;
the power switch being electrically connected between the power supply and the motor;
the first movement guide comprising a plurality of first detent elements and a plurality of second detent elements;
the detent cavity traversing into the head receiver;
the detent connector being connected adjacent to the head connector, opposite to the shaver head;
the plurality of first detent elements being perimetrically distributed around the detent cavity;
the plurality of second detent elements being perimetrically distributed around the detent connector; and
the plurality of first detent elements being enmeshed to the plurality of second detent elements.

9. The hair clipper apparatus as claimed in claim 8 further comprising:
a plurality of textured grips; and
the plurality of textured grips being externally connected about the handle housing.

10. The hair clipper apparatus as claimed in claim 8 further comprising:
a processing unit;
a display screen;
the display screen being externally connected along the handle housing;
the processing unit being connected within the handle housing;
the display screen being electronically connected to the processing unit; and
the power supply, the motor, and the power switch being electronically connected to the processing unit.

11. The hair clipper apparatus as claimed in claim 10 further comprising:
a charging port;
the charging port being integrated into the handle housing;
the charging port being electrically connected to the power supply; and
the charging port being electronically connected to the processing unit.

12. The hair clipper apparatus as claimed in claim 8 further comprising:
a pair of mounting axles;
the second movement guide comprising a first hinge tab, a first fastening aperture, a second hinge tab, and a second fastening aperture;
the first hinge tab being connected adjacent to the head connector, opposite to the handle housing;
the first fastening aperture traversing through the first hinge tab;
the second hinge tab being connected onto the shaver head;
the second fastening aperture traversing through the second hinge tab; and
the pair of mounting axles being mounted through the first fastening aperture and the second fastening aperture.

13. The hair clipper apparatus as claimed in claim 12 further comprising:
the second movement guide further comprising a first detent tab, a plurality of third detent elements, a second detent cavity, a second detent tab, a detent knob, and a plurality of fourth detent elements;
the first detent tab being connected adjacent to the head connector, opposite the to the handle housing;
the first detent tab being positioned offset from the first hinge tab;
the first fastening aperture further traversing through the first detent tab;
the second detent cavity traversing into the first detent tab;
the plurality of third detent elements being perimetrically distributed about the second detent cavity;
the second detent tab being connected adjacent to the shaver head;
the second detent tab being positioned offset from the second hinge tab;
the second fastening aperture traversing through the second hinge tab and the second detent tab;
the detent knob being connected adjacent to the second detent tab;
the plurality of fourth detent elements being perimetrically distributed about the detent knob; and
the plurality of third detent elements being enmeshed to the plurality of fourth detent elements.

14. A hair clipper apparatus comprising:
a handle housing;
a clipper head;
a motor;
a power supply;
a power switch;
a first movement guide;
a second movement guide;
a pair of mounting axles;
the handle housing comprising a shaft aperture and a head receiver;
the clipper head comprising a head connector and a shaver head;
the motor comprising a rotary shaft and a stator body;
the second movement guide comprising a first hinge tab, a first fastening aperture, a second hinge tab, and a second fastening aperture;
the shaft aperture traversing into the handle housing;
the head receiver being positioned around the shaft aperture;
the stator body being connected within the handle housing;
the rotary shaft being rotatably mounted to the stator body;
the rotary shaft being positioned through the shaft aperture;
the head connector being hingedly connected to the head receiver by the first movement guide;
the shaver head being hingedly connected to the head connector, opposite to the shaver head, by the second movement guide;
a first rotation axis of the first movement guide and a second rotation axis of the second movement guide being positioned perpendicular to each other;
the rotary shaft being operatively coupled to the shaver head, wherein the rotary shaft is used to drive a functional motion of the shaver head;
the power switch being electrically connected between the power supply and the motor;
the first hinge tab being connected adjacent to the head connector, opposite to the handle housing;
the first fastening aperture traversing through the first hinge tab;
the second hinge tab being connected onto the shaver head;
the second fastening aperture traversing through the second hinge tab; and
the pair of mounting axles being mounted through the first fastening aperture and the second fastening aperture.

15. The hair clipper apparatus as claimed in claim 14 further comprising:
a plurality of textured grips; and
the plurality of textured grips being externally connected about the handle housing.

16. The hair clipper apparatus as claimed in claim 14 further comprising:
a processing unit;
a display screen;
the display screen being externally connected along the handle housing;
the processing unit being connected within the handle housing;
the display screen being electronically connected to the processing unit; and
the power supply, the motor, and the power switch being electronically connected to the processing unit.

17. The hair clipper apparatus as claimed in claim 16 further comprising:
a charging port;
the charging port being integrated into the handle housing;
the charging port being electrically connected to the power supply; and
the charging port being electronically connected to the processing unit.

18. The hair clipper apparatus as claimed in claim 14 further comprising:
the head receiver comprising a first detent cavity;
the head connector comprising a detent connector;
the first movement guide comprising a plurality of first detent elements and a plurality of second detent elements;
the detent cavity traversing into the head receiver;
the detent connector being connected adjacent to the head connector, opposite to the shaver head;
the plurality of first detent elements being perimetrically distributed around the detent cavity;
the plurality of second detent elements being perimetrically distributed around the detent connector; and
the plurality of first detent elements being enmeshed to the plurality of second detent elements.

19. The hair clipper apparatus as claimed in claim 14 further comprising:
the second movement guide further comprising a first detent tab, a plurality of third detent elements, a second detent cavity, a second detent tab, a detent knob, and a plurality of fourth detent elements;
the first detent tab being connected adjacent to the head connector, opposite the to the handle housing;
the first detent tab being positioned offset from the first hinge tab;
the first fastening aperture further traversing through the first detent tab;
the second detent cavity traversing into the first detent tab;
the plurality of third detent elements being perimetrically distributed about the second detent cavity;
the second detent tab being connected adjacent to the shaver head;
the second detent tab being positioned offset from the second hinge tab;
the second fastening aperture traversing through the second hinge tab and the second detent tab;
the detent knob being connected adjacent to the second detent tab;
the plurality of fourth detent elements being perimetrically distributed about the detent knob; and
the plurality of third detent elements being enmeshed to the plurality of fourth detent elements.
